(19) United States
(12) Patent Application Publication
(10) Pub. No.: US 2023/0074821 A1
(43) Pub. Date: Mar. 9, 2023

(54) TIME-OF-FLIGHT SENSORS, METHODS, AND NON-TRANSITORY COMPUTER-READABLE MEDIA WITH PHASE FILTERING OF DEPTH SIGNAL

(71) Applicant: Sony Semiconductor Solutions Corporation, Kanagawa (JP)

(72) Inventors: Sa Xiao, Valkenswaard (NL); Ping Wah Wong, Sunnyvale, CA (US); Kevin Chan, San Jose, CA (US)

(21) Appl. No.: 17/470,466

(22) Filed: Sep. 9, 2021

(51) Int. Cl. G01S 7/48; G01S 17/08

(52) U.S. Cl. CPC G01S 7/4808; G01S 17/08

(57) ABSTRACT

Time-of-Flight (ToF) sensors, methods, and non-transitory computer-readable media. In one example of the present disclosure, a ToF sensor includes an array of pixels and processing circuitry. At least one pixel of the array of pixels is configured to generate a depth signal. The processing circuitry is configured to determine a phase value from the depth signal and perform phase filtering on the phase value.

### BACKGROUND OF THE INVENTION

### 1. Field of the Invention

This application relates to Time-of-Flight (ToF) sensors, methods, and non-transitory computer-readable media with phase filtering of a depth signal.

### 2. Description of Related Art

Time-of-flight (TOF) is a technique used in rebuilding three-dimensional (3D) images. The TOF technique includes calculating the distance between a light source and an object by measuring the time for light to travel from the light source to the object and return to a light-detection sensor, where the light source and the light-detection sensor are located in the same device.

Conventionally, an infrared light-emitting diode (LED) is used as the light source to ensure high immunity with respect to ambient light. The information obtained from the light that is reflected by the object may be used to calculate a distance between the object and the light-detection sensor, and the distance may be used to reconstruct the 3D images. The 3D images that are reconstructed may then be used in gesture and motion detection. Gesture and motion detection is being used in different applications including automotive, drone, and robotics, which require more accurate and faster obtainment of the information used to calculate the distance between the object and the light-detection source in order to decrease the amount of time necessary to reconstruct the 3D images.

Image sensing devices typically include an image sensor, an array of pixel circuits, signal processing circuitry and associated control circuitry. Within the image sensor itself, charge is collected in a photoelectric conversion device of the pixel circuit as a result of impinging light. Subsequently, the charge in a given pixel circuit is read out as an analog signal, and the analog signal is converted to digital form by an analog-to-digital converter (ADC).

However, there are many noise sources that affect an output of the ToF sensor. For example, some noise sources include shot noise in the photon, KTC noise in the circuit, system noise and fixed pattern noise from pixel and circuit design, and quantization noise in the ADC. All of these noise sources in the pixel data will contribute to depth noise.

### BRIEF SUMMARY OF THE INVENTION

Due to depth aliasing and other problems, existing filtering methods are performed on raw pixel data domain. However, the raw pixel data domain typically includes one or more frames of pixel values, and hence, requires a specific amount of frame memory to store the raw pixel data for filtering. Accordingly, there exists a need for noise filtering methods for a ToF sensor that do not suffer from these deficiencies.

As described in greater detail below, phase filtering methods are performed directly on a depth signal, which typically does not require frame memory in the case of spatial filtering. If temporal filtering is implemented, the amount of frame memory required will still be less than the amount of frame memory needed for filtering of the raw pixel data. Additionally, the phase filtering methods of the present disclosure solve the issue of distance aliasing during the filtering process. Further, the phase filtering methods of the present disclosure utilize both distance information and pixel strength.

Various aspects of the present disclosure relate to ToF sensors, methods, and non-transitory computer-readable media. In one aspect of the present disclosure, a ToF sensor includes an array of pixels and processing circuitry. At least one pixel of the array of pixels is configured to generate a depth signal. The processing circuitry is configured to determine a phase value from the depth signal and perform phase filtering on the phase value.

Another aspect of the present disclosure is a method for filtering noise. The method includes determining, with processing circuitry, a phase value from a depth signal that is generated by one pixel from an array of pixels. The method also includes performing, with the processing circuitry, phase filtering on the phase value.

In yet another aspect of the present disclosure, a non-transitory computer-readable medium comprises instructions that, when executed by an electronic processor, cause the electronic processor to perform a set of operations. The set of operations includes determining a phase value from a depth signal that is generated by one pixel from an array of pixels. The set of operations also includes performing phase filtering on the phase value.

This disclosure may be embodied in various forms, including hardware or circuits controlled by computer-implemented methods, computer program products, computer systems and networks, user interfaces, and application programming interfaces; as well as hardware-implemented methods, signal processing circuits, image sensor circuits, application specific integrated circuits, field programmable gate arrays, digital signal processors, and other suitable forms. The foregoing summary is intended solely to give a general idea of various aspects of the present disclosure, and does not limit the scope of the present disclosure.

### BRIEF DESCRIPTION OF THE DRAWINGS

These and other more detailed and specific features of various embodiments are more fully disclosed in the following description, reference being had to the accompanying drawings, in which:

FIG. 1 is a circuit diagram that illustrates an exemplary image sensor, in accordance with various aspects of the present disclosure.

FIG. 2 is a diagram illustrating five different categories of pixel configurations.

FIGS. 3 and 4 are diagrams illustrating a comparative method of filtering pixels using a low pass filter.

FIG. 5 is a flow diagram illustrating a first example method for filtering the pixels, in accordance with various aspects of the present disclosure.

FIG. 6 is a flow diagram illustrating a second example method for filtering the pixels, in accordance with various aspects of the present disclosure.

FIG. 7 is a diagram illustrating a third example method for filtering the pixels, in accordance with various aspects of the present disclosure.

FIG. 8 is a diagram illustrating three different examples of the vertical and horizontal components of the pixels in four quadrants, in accordance with various aspects of the present disclosure.

FIG. 9 is a diagram illustrating a fourth example method for filtering the pixels, in accordance with various aspects of the present disclosure.

FIG. 10 is a diagram illustrating four different examples of the vertical and horizontal components of the pixels in four quadrants, in accordance with various aspects of the present disclosure.

FIG. 11 is a diagram illustrating a sixth example method for filtering the pixels, in accordance with various aspects of the present disclosure.

FIG. 12 is a diagram illustrating a seventh example method for filtering the pixels, in accordance with various aspects of the present disclosure.

FIG. 13 is chart illustrating the number of frame buffers required between raw data filtering and phase filtering of the pixels, in accordance with various aspects of the present disclosure.

### DETAILED DESCRIPTION

In the following description, numerous details are set forth, such as flowcharts, equations, and circuit configurations. It will be readily apparent to one skilled in the art that these specific details are exemplary and do not to limit the scope of this application.

In this manner, the present disclosure provides improvements in the technical field of time-of-flight sensors, as well as in the related technical fields of image sensing and image processing.

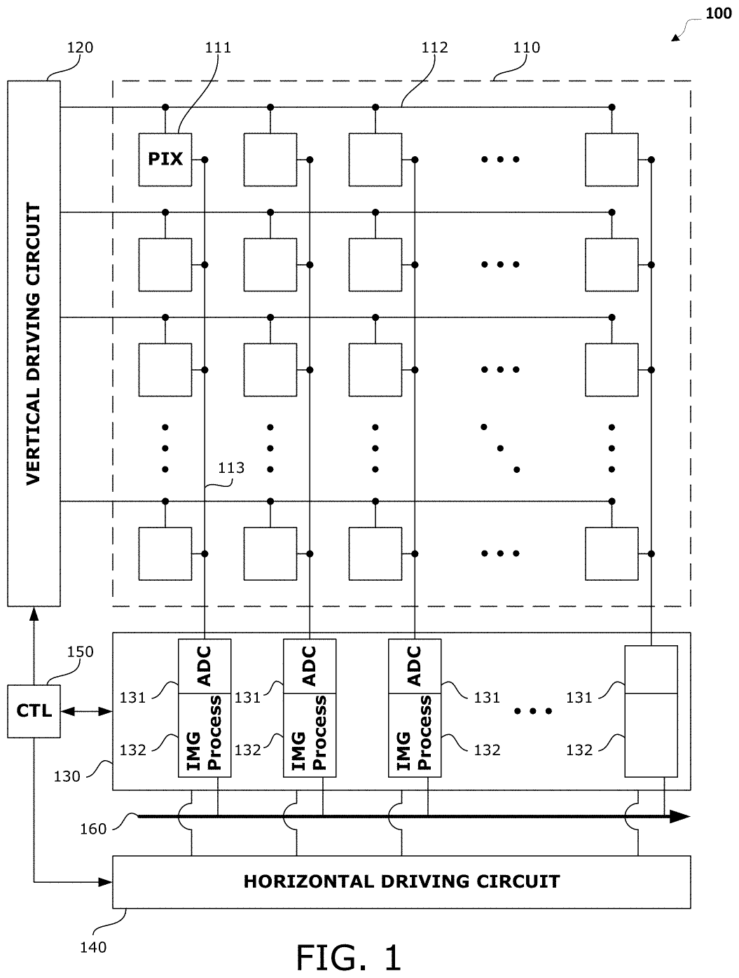

FIG. 1 illustrates an exemplary image sensor 100, in accordance with various aspects of the present disclosure. The image sensor 100 includes an array 110 of pixels 111 located at intersections where horizontal signal lines 112 and vertical signal lines 113 cross one another. The horizontal signal lines 112 are operatively connected to a vertical driving circuit 120 (for example, a row scanning circuit) at a point outside of the array 110. The horizontal signal lines 112 carry signals from the vertical driving circuit 120 to a particular row of the array 110 of pixels 111. The pixels 111 in a particular column output an analog signal corresponding to an amount of incident light to the pixels in the vertical signal line 113. For illustration purposes, only a small number of the pixels 111 are actually shown in FIG. 1. In some examples, the image sensor 100 may have tens of millions of pixels 111 (for example, “megapixels” or MP) or more.

The vertical signal line 113 conducts the analog signal for a particular column to a column circuit 130. In the example of FIG. 1, one vertical signal line 113 is used for each column in the array 110. In other examples, more than one vertical signal line 113 may be provided for each column. In yet other examples, each vertical signal line 113 may correspond to more than one column in the array 110. The column circuit 130 may include one or more individual analog to digital converters (ADC) 131 and image processing circuits 132. As illustrated in FIG. 1, the column circuit 130 includes an ADC 131 and an image processing circuit 132 for each vertical signal line 113. In other examples, each set of ADC 131 and image processing circuit 132 may correspond to more than one vertical signal line 113.

The column circuit 130 is at least partially controlled by a horizontal driving circuit 140 (for example, a column scanning circuit). Each of the vertical driving circuit 120, the column circuit 130, and the horizontal driving circuit 140 receive one or more clock signals from a controller 150. The controller 150 controls the timing and operation of various image sensor components.

In some examples, the controller 150 controls the column circuit 130 to convert analog signals from the array 110 to digital signals. The controller 150 may also control the column circuit 130 to output the digital signals via signal lines 160 to an output circuit for additional signal processing, storage, transmission, or the like. In some examples, the controller 150 includes an electronic processor (for example, one or more microprocessors, one or more digital signal processors, application specific integrated circuits (ASIC), field programmable gate arrays (FPGA), or other suitable processing devices) and a memory.

Additionally, the column circuit 130 may perform various signal processing methods, and in particular, phase filtering methods as described in greater detail below. For example, one or more of the image processing circuits 132 may be controlled by the electronic processor of the controller 150 to perform the phase filtering methods as described below and output the processed signals as the digital signals via the signal lines 160 to an output circuit for additional signal processing, storage, transmission, or the like. In some examples, the electronic processor of the controller 150 controls the memory of the controller 150 to store digitals signals before or after performing the phase filtering methods as described below. In some examples, the memory of the controller 150 is a non-transitory computer-readable medium that includes computer readable code stored thereon for performing the various signal processing methods. Examples of a non-transitory computer-readable medium are described in greater detail below.

In some examples, the one or more image processing circuits 132 may interface to memory via the signal lines 160. The memory, e.g., static random access memory (SRAM) or dynamic random access memory (DRAM), may be implemented on the same piece of semiconductor as the image sensor 100, or it may be implemented in a separate memory chip which is connected to the image sensor via the signal lines 160. In the case of implementation on a separate memory chip, the memory chip may be physically stacked with the image sensor and the electrical connection between the two chips may be done by through silicon vias (TSV) or other connection methods. The memory is generally referred to as the “frame buffer” which stores the digital signals for all pixels comprising a frame before performing the phase filtering methods as described below.

Alternatively, in some examples, image processing circuits (for example, one or more microprocessors, one or more digital signal processors, application specific integrated circuits (ASIC), field programmable gate arrays (FPGA), or other suitable processing devices) that includes SRAM or DRAM which collectively form a “frame buffer” and are external to the image sensor 100 may receive the digital signals via a bus connected to the signal lines 160 and perform the phase filtering methods as described herein. Additionally or alternatively, the image processing circuits that are external to the image sensor 100 may retrieve the digital signals from the memory of the controller 150 that stores the digital signals and perform the phase filtering methods as described herein.

In a ToF sensor, the phase value of certain pixels may be an outlier within a configuration of multiple pixels due to noise, received signal strength, and other factors. In ToF processing, the outlier phase values are detected and declared to be invalid pixels in a given pixel configuration.

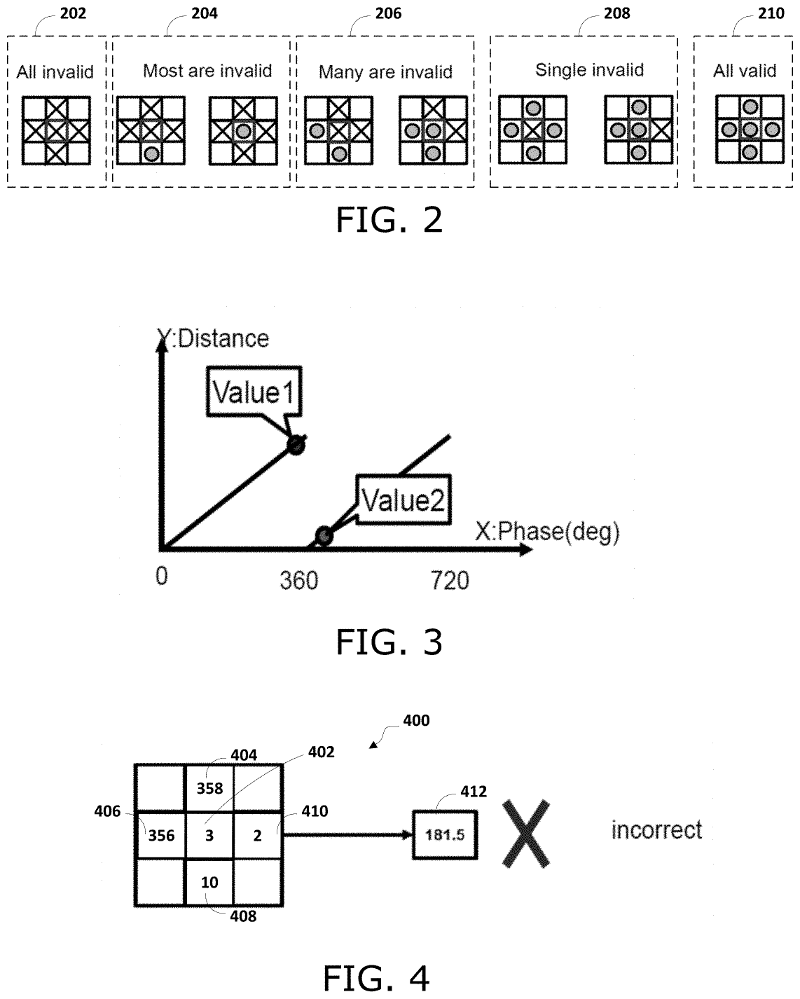

FIG. 2 is a diagram illustrating five different categories 202-210 of pixel configurations. A first category 202 is an “all invalid” pixel configuration including all invalid pixels as represented by five “X” marks in the five pixel locations of the pixel configuration. A second category 204 is a “most are invalid” pixel configuration including four invalid pixels as represented by four “X” marks and one valid pixel represented by one “O” mark in the five pixel locations of the pixel configuration. A third category 206 is a “many are invalid” pixel configuration including three or two invalid pixels as represented by three or two “X” marks and two or three valid pixels represented by two or three “O” marks in the five pixel locations of the pixel configuration. A fourth category 208 is a “single invalid” pixel configuration including one invalid pixel as represented by one “X” mark and four valid pixels represented by four “O” marks in the five pixel locations of the pixel configuration. A fifth category 210 is a “all valid” pixel configuration including zero invalid pixels and five valid pixels represented by five “O” marks in the five pixel locations of the pixel configuration.

Noise filtering is a form of weighted or unweighted pixel averaging, either by linear or non-linear methods. Ideally, invalid pixels are not included in the pixel averaging to avoid distorting the valid pixels. FIGS. 5-13 illustrate different example methods of noise filtering using phase filtering without distorting the valid pixels with invalid pixels, in according with various aspects of the present disclosure.

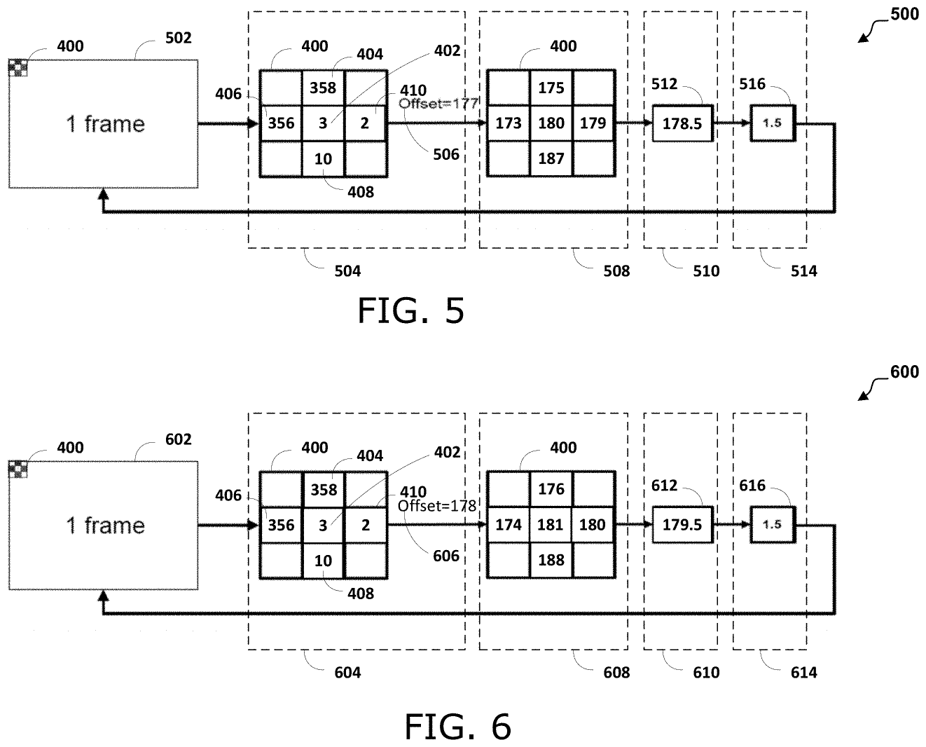

FIGS. 3 and 4 illustrate a comparative method of filtering pixels 400 using a low pass filter. As illustrated in FIG. 3, a ToF sensor has a wrap around property at 360 degrees, i.e., a phase value of 0 degrees is exactly the same as a phase value of 360 degrees. The wrap around property implies that a phase value of 355 degrees is close to another phase value of 5 degrees. Additionally, as illustrated in FIG. 3, the Value 1 may be a phase value of 358 or 356 degrees and the Value 2 may be a phase value of 2 or 10 degrees.

Specifically, as illustrated in FIG. 4, the pixels 400 includes a center pixel 402 and four neighboring pixels 404-410. The center pixel 402 has a phase value of 3 degrees. The first neighboring pixel 404 has a phase value of 356 degrees. The second neighboring pixel 406 has a phase value of 358 degrees. The third neighboring pixel 408 has a phase value of 10 degrees. The fourth neighboring pixel 410 has a phase value of 2 degrees. The weighted average output 412 of the center pixel 402 may be determined by expression (1) below where W_{(k,l)} are weights.

$$output ( i , j ) = \frac{358 * {W}_{( i - 1 , j )} + 10 * {W}_{( i + 1 , j )} + 356 * {W}_{( i , j - 1 )} + 2 * {W}_{( i , j + 1 )}}{\sum {W}_{( i , j )}} \qquad ( 1 )$$

Generally the weights can be chosen by many linear or non-linear digital filter design methods such as considering the effect of the pixel noise, the degree of blurring the data, simplicity of implementation, and others. For ease of understanding, it may be assumed that all weights W=1 in the above expression (1). In this example, the average output 412 of the center pixel 402 with respect to neighboring pixels 404-410 is then a phase value of 181.5 degrees when the actual phase value of the center pixel 402 is 3 degrees. The correct average output value should be close to 360 degrees (or 0 degrees). The comparative filtering method in the above expression (1) (i.e., straight averaging) does not work for phase values of pixels that are close to 360 degrees or 0 degrees because it does not take into account the wrap around property of the phase values.

FIG. 5 is a flow diagram illustrating a first example method 500 for filtering the pixels 400, in accordance with various aspects of the present disclosure. As illustrated in FIG. 5, the pixels 400 are a subset of pixels in one frame 502 (e.g., the array 110 of FIG. 1).

At block 504, validity of the center pixel 402 is examined. If it is not valid, then the filtering embodiment skips the pixel and move the window of pixels 400 to the next pixel location. Assuming the center pixel 402 is valid, processing circuitry (e.g., the electronic processor of the controller 150, the one or more image processing circuits 132, processing circuitry external to the image sensor 100, other suitable processing circuitry, or a combination thereof) may calculate an offset 506 to shift the phase value of the center pixel 402 to be centered at 180 degrees. The offset 506 is equal to 180 degrees minus the actual phase value of the center pixel 402. In the example of FIG. 5, the offset 506 is 180 degrees minus 3 degrees, which is 177 degrees.

At block 508, assuming the neighboring pixels 404-410 are valid, then the processing circuitry applies a modulo shift to each of the phase values of the neighboring pixels 404-410 using the offset 506. In the example of FIG. 5, the phase values of the neighboring pixels 404-410 are individually modulo shifted by 177 degrees, which is 175 degrees, 173 degrees, 187 degree, and 179 degrees, respectively.

At block 510, the processing circuitry calculates a weighted mean 512 based on the modulo shifted value with expression (2) below.

$$weighted mean ( phases ) = \frac{{\sum }_{i = 0}^{i = n - 1} {w}_{i} * {shifted\_phase}_{i} * {1}_{( pixel i is valid )}}{{\sum }_{i = 0}^{i = n - 1} {w}_{i} * {1}_{( pixel i is valid )}} \qquad ( 2 )$$

As illustrated in FIG. 5, according to the above expression (2), the weighted mean 512 based on the modulo shifted value is a phase value of 178.5 degrees.

The description in the previous two paragraphs assumes the pixels 404-410 are valid. In general, blocks 508 and 510 includes in the calculation only those pixels that are valid. The invalid neighboring pixels are ignored.

At block 514, the processing circuitry shifts back the weighted mean 512 using the offset 506 to generate an average output phase value 516 (i.e., a “filtered phase value”) with respect to the center pixel 402. As illustrated in FIG. 5, the average output phase value 516 is 1.5 degrees, which is 178.5 degrees shifted back by 177 degrees.

After generating the average output phase value 516 with respect to the center pixel 402, the processing circuitry selects a new center pixel with four neighboring pixels and repeats blocks 504, 508, 510, and 514 for the new center pixel. The processing circuitry also performs blocks 504, 508, 510, and 514 for each center pixel in the frame 502 that has four neighboring pixels, assuming all of the pixels are valid. The weighted average processing in FIG. 5 may also include the corner pixels in the 3×3 window, i.e., eight neighboring pixels are considered instead of four. Furthermore, the processing is not restricted to a 3×3 window. Other window sizes may also be used in the filtering method.

FIG. 6 is a flow diagram illustrating a second example method 600 for filtering the pixels 400, in accordance with various aspects of the present disclosure. As illustrated in FIG. 6, the pixels 400 are a subset of pixels in one frame 602 (e.g., the array 110 of FIG. 1).

At block 604, validity of the center pixel 402 is examined. If it is not valid, then the value from a valid neighboring pixels among 404, 406, 408 and 410 are chosen and is copied to the center pixel. The filtering continues as described in the following using the new value for the center pixel. Specifically, the processing circuitry may calculate an offset 606 to shift the phase value of a valid neighboring pixel to be centered at 180 degrees. The offset 606 is simply 180 degrees minus the actual phase value of the valid neighboring pixel. In the example of FIG. 6, the offset 606 is 180 degrees minus 2 degrees (i.e., the phase value of the neighboring pixel 410 that is a valid pixel), which is 178 degrees.

At block 608, assuming the neighboring pixels 404-410 are valid, then the processing circuitry modulo shifts the phase values of the neighboring pixels 404-410 using the offset 606. In the example of FIG. 6, the phase values of the neighboring pixels 404-410 are individually modulo shifted by 178 degrees, which is 176 degrees, 174 degrees, 188 degree, and 180 degrees, respectively.

At block 610, the processing circuitry calculates a weighted mean 612 based on the modulo shifted value with the expression (2) described above. As illustrated in FIG. 6, the weighted mean 612 based on the modulo shifted value is a phase value of 179.5 degrees.

At block 614, the processing circuitry shifts back the weighted mean 612 using the offset 606 to generate an average output phase value 616 with respect to the center pixel 402. As illustrated in FIG. 6, the average output phase value 616 is 1.5 degrees, which is 179.5 degrees shifted back by 178 degrees.

After generating the average output phase value 616 with respect to the center pixel 402, the processing circuitry selects a new center pixel with four neighboring pixels and repeats blocks 604, 608, 610, and 614 for the new center pixel. The processing circuitry also performs blocks 604, 608, 610, and 614 for each center pixel in the frame 602 that has four neighboring pixels, assuming all of the center pixels are invalid.

The description for FIG. 6 assumes the pixels 404-410 are valid. In general, blocks 608 and 610 includes in the calculation only those pixels that are valid. The invalid neighboring pixels are ignored. The weighted average processing in FIG. 6 may also include the corner pixels in the 3×3 window, i.e., eight neighboring pixels are considered instead of four. Furthermore, the processing is not restricted to a 3×3 window. Other window sizes may also be used in the filtering method.

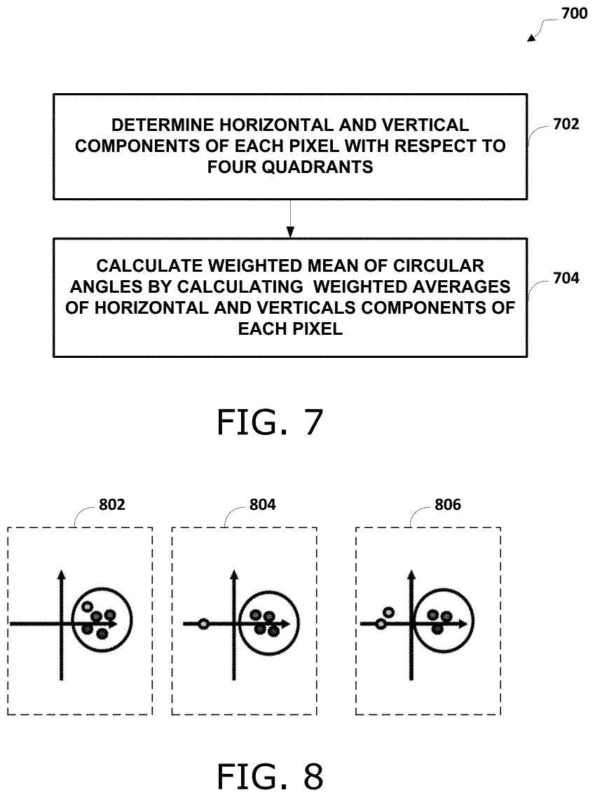

FIG. 7 is a diagram illustrating a third example method 700 for filtering the pixels 400, in accordance with various aspects of the present disclosure. In the third example method 700, the processing circuitry determines horizontal and vertical components of the phase value at each pixel of the pixels 400 with respect to four quadrants (at block 702). A phase value in the first quadrant is composed of a positive vertical and horizontal component. A phase value in the second quadrant is composed of a positive vertical component and a negative horizontal component. A phase value in the third quadrant is composed of a negative vertical and horizontal component. A phase value in the fourth quadrant is composed of a negative vertical component and a positive vertical component.

Additionally, in the third example method 700, the processing circuitry calculates a weighted mean of circular angles by calculating the arctangent of weighted averages of horizontal and verticals components of the phase value at each pixel in the pixels 400 (at block 704). For example, the weighted mean may be determined by expression (3) below.

$$weighted mean ( phases ) = atan 2 ( \frac{{\sum }_{i = 0}^{i = n - 1} {w}_{i} * sin ( {phase}_{i} ) * {1}_{( pixel i is valid )}}{{\sum }_{i = 0}^{i = n - 1} {w}_{i} * {1}_{( pixel i is valid )}} , \\ \frac{{\sum }_{i = 0}^{i = n - 1} {w}_{i} * cos ( {phase}_{i} ) * {1}_{( pixel i is valid )}}{{\sum }_{i = 0}^{i = n - 1} {w}_{i} * {1}_{( pixel i is valid )}} ) \qquad ( 3 )$$

The third example method 700 does not have the phase wrap around problem described above because the phase values are not directly averaged together. Additionally, in the third example method 700, only the valid pixels are included. Further, the kernel size of the selected area is not limited to a N×N kernel. The kernel size may be the 4 closest neighboring pixels or other suitable number of closest neighboring pixels.

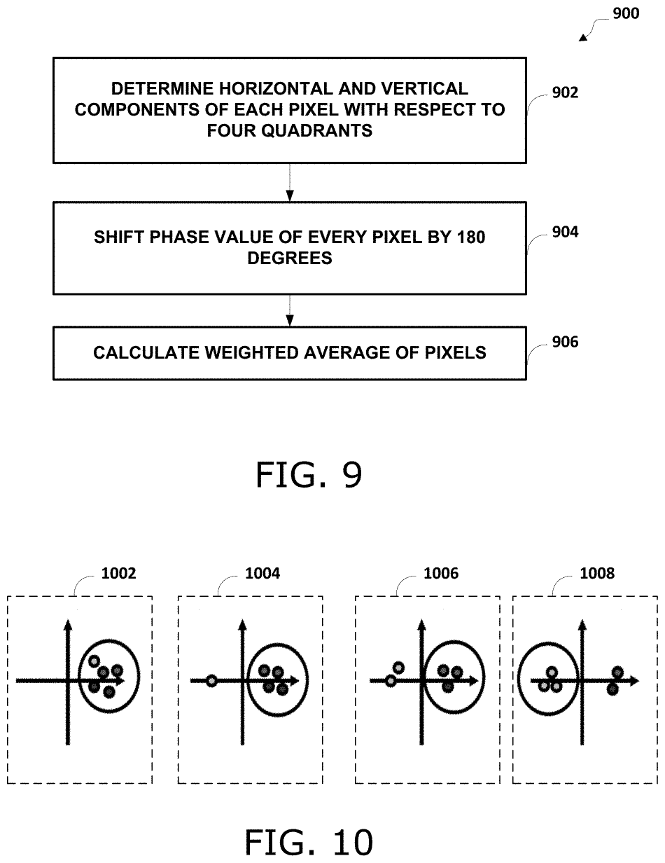

FIG. 8 is a diagram illustrating three different examples of the vertical and horizontal components of the pixels 400 in four quadrants, in accordance with various aspects of the present disclosure. As illustrated in FIG. 8, a first example 802 has all of the phase values of the pixels 400 in the first and fourth quadrants. In the first example 802, the weighted mean calculated in FIG. 7 would include all of the vertical and horizontal components of the phase values of the pixels 400 in the first and fourth quadrants.

As illustrated in FIG. 8, a second example 804 has the phase values of four pixels of the pixels 400 in the first and fourth quadrants. In the second example 804, the weighted mean calculated in FIG. 7 would include the vertical and horizontal components of the phase values of four pixels of the pixels 400 in the first and fourth quadrants. The other pixel of the pixels 400 is deemed to be invalid.

As illustrated in FIG. 8, a third example 806 has the phase values of three pixels of the pixels 400 in the first and fourth quadrants. In the third example 806, the weighted mean calculated in FIG. 7 would include the vertical and horizontal components of the phase values of three pixels of the pixels 400 in the first and fourth quadrants. The other two pixels of the pixels 400 are deemed to be invalid.

FIG. 9 is a diagram illustrating a fourth example method 900 for filtering the pixels 400, in accordance with various aspects of the present disclosure. In the fourth example method 900, the processing circuitry determines horizontal and vertical components of the phase value of each pixel of the pixels 400 with respect to four quadrants (at block 902). A phase value in the first quadrant is composed of a positive vertical and horizontal component. A phase value in the second quadrant is composed of a positive vertical component and a negative horizontal component. A phase value in the third quadrant is composed of a negative vertical and horizontal component. A phase value in the fourth quadrant is composed of a negative vertical component and a positive vertical component.

When the processing circuitry determines that most valid pixels are in the first quadrant and the fourth quadrant, then the processing circuitry selectively shifts the phase value of every pixel by 180 degrees (at block 904).

After shifting the phase value of every pixel by 180 degrees, the processing circuitry calculates the weighted average similar to the first example method 500 as described above in expression (2) and in FIG. 5 (at block 906). However, several differences exist between the first example method 500 and the fourth example method 900.

First, the first example method 500 uses the center pixel to determine whether a shift is necessary. The fourth example method 900 uses the entire neighborhood of pixels to determine whether a shift is necessary.

Second, the first example method 500 shifts by an offset that depends on a phase value of the center pixel. The fourth example method 900 may always shifts by 180 degrees. In some examples, the fourth example method 900 may shift by a different constant amount that may be dependent on the center pixel.

Third, the first example method 500 does not check the number of valid pixels in the aliasing quadrants. The fourth example method 900 always checks the number of valid pixels in the aliasing quadrants.

The fourth example method 900 does not have the phase wrap around problem described above because the phase values are always shifted by a specific amount. Further, the kernel size of the selected area is not limited to a N×N kernel. The kernel size may be the 4 closest neighboring pixels or other suitable number of closest neighboring pixels.

FIG. 10 is a diagram illustrating four different examples of the vertical and horizontal components of the pixels 400 in four quadrants, in accordance with various aspects of the present disclosure. As illustrated in FIG. 10, a first example 1002 has all of the phase values of the pixels 400 in the first and fourth quadrants. In the first example 1002, the weighted average calculated in FIG. 9 would include all of the pixels 400.

As illustrated in FIG. 10, a second example 1004 has the phase values of four pixels of the pixels 400 in the first and fourth quadrants. In the second example 1004, the weighted average calculated in FIG. 9 would include the four pixels of the pixels 400 in the first and fourth quadrants. The other pixel of the pixels 400 is deemed to be invalid.

As illustrated in FIG. 10, a third example 1006 has the phase values of three pixels of the pixels 400 in the first and fourth quadrants. In the third example 1006, the weighted average calculated in FIG. 9 would include the three pixels of the pixels 400 in the first and fourth quadrants. The other two pixels of the pixels 400 are deemed to be invalid.

Lastly, as illustrated in FIG. 10, a fourth example 1008 has the phase values of two pixels of the pixels 400 in the first and fourth quadrants. In the fourth example 1008, the phase shifting of the pixels are unnecessary because the majority of the pixels' phases are in the second and third quadrants. In this case, the weighted averaging is performed on the pixels in the second and third quadrants directly without phase shifting.

The methods 500-700 and 900 described above are spatial filters that use one or more spatial neighbor pixels to filter a center pixel. However, the methods 500-700 and 900 are not limited to spatial filters. For example, pixels in different frames may be used as the neighboring pixels to temporally filter a center pixel in a current frame (i.e., frame n).

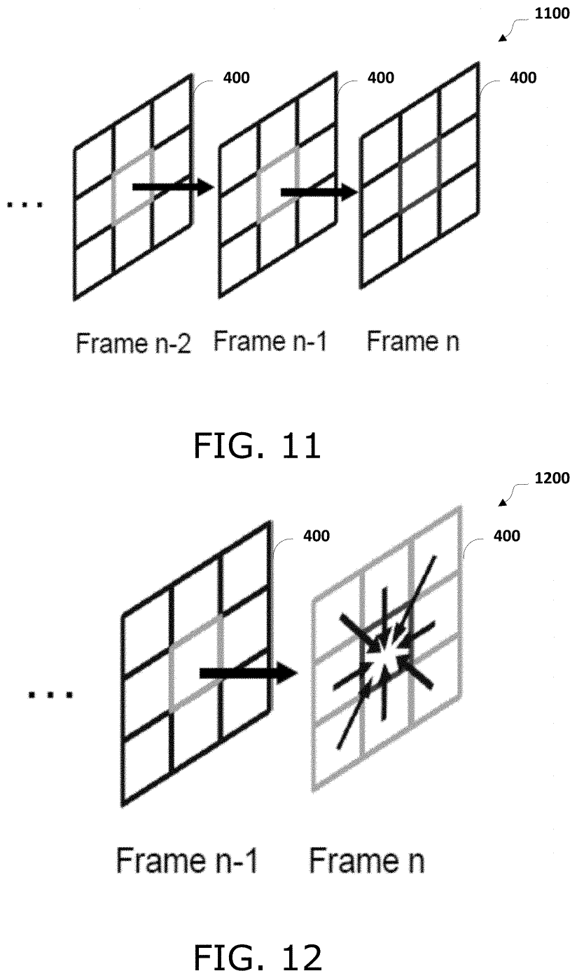

FIG. 11 is a diagram illustrating a sixth example method 1100 for filtering the pixels 400, in accordance with various aspects of the present disclosure. As illustrated in FIG. 11, a center pixel in different frames may be used as the neighboring pixels to filter the same center pixel in a current frame (i.e., frame n). In other words, the neighboring pixels in the methods 500-700 and 900 may be phase values of the same center pixel in earlier frames.

Specifically, as illustrated in FIG. 11, the neighboring pixels in the methods 500-700 and 900 may be earlier phase values of the center pixel 402 in frame n−1 and frame n−2. However, the total number of frames for temporal filtering is not limited to three frames (i.e., frame n, frame n−1, and frame n−2). The total number of frames for temporal filter may be any number of frames (i.e., frames n−m and/or frames n+p). Further, the kernel size of the selected area is not limited to a N×N kernel. The kernel size may be the 4 closest neighboring pixels or other suitable number of closest neighboring pixels.

FIG. 12 is a diagram illustrating a seventh example method 1200 for filtering the pixels 400, in accordance with various aspects of the present disclosure. As illustrated in FIG. 12, pixels in different frames may be used as the neighboring pixels to filter the same center pixel in a current frame (i.e., frame n). In other words, the neighboring pixels in the methods 500-700 and 900 may be phase values of the same center pixel in earlier frames in addition to phase value of the neighboring pixels in a current frame.

Specifically, as illustrated in FIG. 12, the neighboring pixels in the methods 500-700 and 900 may be an earlier phase value of the center pixel 402 in frame n−1 in addition to the phase values of the neighboring pixels of the center pixel 402 in the current frame n. However, the total number of frames for temporal and spatial filtering is not limited to two frames (i.e., frame n and frame n−1). The total number of frames for temporal filter may be any number of frames (i.e., frames n−m and/or frames n+p). Further, the kernel size of the selected area is not limited to a N×N kernel. The kernel size may be the 4 closest neighboring pixels or other suitable number of closest neighboring pixels.

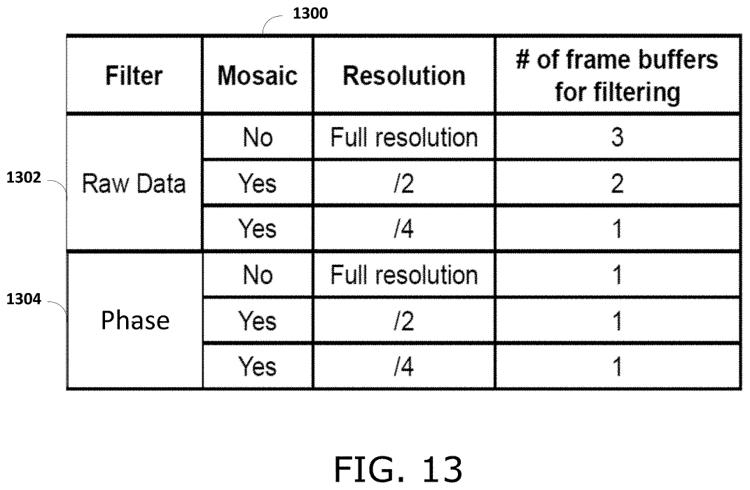

FIG. 13 is chart illustrating the number of frame buffers required between raw data filtering 1302 and phase filtering 1304 of the pixels 400, in accordance with various aspects of the present disclosure.

As illustrated in FIG. 13, the raw data filtering 1302 of the pixels 400 at full resolution requires three frame buffers, at half resolution with phase mosaicing requires two frame buffers, and at quarter resolution with phase mosaicing requires one frame buffer. Additionally, as illustrated in FIG. 13, the phase filtering 1304 of the pixels 400 (i.e., methods 500-700, 900, 1100, and 1200) at full resolution requires one frame buffer, at half resolution with phase mosaicing requires one frame buffer, and at quarter resolution with phase mosaicing requires one frame buffer. Therefore, the phase filtering 1304 requires one-third of the frame buffers for filtering as compared to the raw data filtering 1302. In other words, the more input frames required for a given Time-of-Flight (ToF) model, the lower the number of frame buffers will be required when implementing the phase filtering 1304 of the present disclosure over the raw data filtering 1302.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain examples, and should in no way be construed so as to limit the claims.

Accordingly, it is to be understood that the above description is intended to be illustrative and not restrictive. Many examples and applications other than the examples provided would be apparent upon reading the above description. The scope should be determined, not with reference to the above description, but should instead be determined with reference to the appended claims, along with the full scope of equivalents to which the claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A Time-of-Flight (ToF) sensor comprising:
an array of pixels, at least one pixel of the array of pixels configured to generate a depth signal; and
processing circuitry configured to
determine a phase value from the depth signal, and
perform phase filtering on the phase value.

2. The ToF sensor according to claim 1, wherein, to perform the phase filtering on the phase value, the processing circuitry is further configured to
determine neighboring phase values from pixels that neighbor the at least one pixel,
determine an offset value from the phase value,
shift the phase value and the neighboring phase values by the offset value that is determined,
determine a weighted mean from the phase value that is shifted and the neighboring phase values that are shifted, and
generate a filtered phase value by shifting the weighted mean back by the offset value.

3. The ToF sensor according to claim 1, wherein, to perform the phase filtering on the phase value, the processing circuitry is further configured to
determine neighboring phase values from pixels that neighbor the at least one pixel,
determine whether the at least one pixel is valid,
determine a valid pixel from the pixels that neighbor the at least one pixel in response to determining that the at least one pixel is not valid,
determine an offset value from a neighboring phase value of the valid pixel,
shift the phase value and the neighboring phase values by the offset value,
determine a weighted mean from the phase value that is shifted and the neighboring phase values that are shifted, and
generate a filtered phase value by shifting the weighted mean back by the offset value.

4. The ToF sensor according to claim 1, wherein, to perform the phase filtering on the phase value, the processing circuitry is further configured to
determine neighboring phase values from pixels that neighbor the at least one pixel,
determine whether the at least one pixel is valid,
determine a offset value from the phase value in response to determining that the at least one pixel is valid,
shift the phase value and the neighboring phase values by the offset value,
determine a weighted mean from the phase value that is shifted by the offset value and the neighboring phase values that are shifted by the offset value, and
generate a filtered phase value by shifting the weighted mean back by the offset value.

5. The ToF sensor according to claim 1, wherein, to perform the phase filtering on the phase value, the processing circuitry is further configured to
determine horizontal and vertical components of the at least one pixel and pixels that neighbor the at least one pixel with respect to four quadrants,
calculate a weighted average of horizontal components of the at least one pixel and the pixels that neighbor the at least one pixel,
calculate a weighted average of vertical components of the at least one pixel and the pixels that neighbor the at least one pixel, and
calculate a weighted mean of circular angles based on the weighted average of the horizontal components and the weighted average of the vertical components,
wherein the weighted mean is a filtered phase value of the at least one pixel.

6. The ToF sensor according to claim 1, wherein, to perform the phase filtering on the phase value, the processing circuitry is further configured to
determine horizontal and vertical components of the at least one pixel and pixels that neighbor the at least one pixel with respect to four quadrants,
responsive to determining that a majority of the horizontal and vertical components of the at least one pixel and pixels that neighbor the at least one pixel are in a first quadrant and a fourth quadrant of the four quadrants, shift a phase value of the at least one pixel and neighboring phase values of the pixels that neighbor the at least one pixel by a 180 degrees, and
calculate a weighted average from the phase value that is shifted and the neighboring phase values that are shifted,
wherein the weighted average is a filtered phase value of the at least one pixel.

7. The ToF sensor according to claim 1, wherein, to perform the phase filtering on the phase value, the processing circuitry is further configured to
perform spatial phase filtering,
perform temporal phase filtering, and
perform a combination of spatial phase filtering and temporal phase filtering.

8. A method comprising:
determining, with processing circuitry, a phase value from a depth signal that is generated by one pixel from an array of pixels; and
performing, with the processing circuitry, phase filtering on the phase value.

9. The method according to claim 8, wherein performing the phase filtering on the phase value further includes
determining neighboring phase values from pixels that neighbor the at least one pixel,
determining an offset value from the phase value,
shifting the phase value and the neighboring phase values by the offset value that is determined,
determining a weighted mean from the phase value that is shifted and the neighboring phase values that are shifted, and
generating a filtered phase value by shifting the weighted mean back by the offset value.

10. The method according to claim 8, wherein performing the phase filtering on the phase value further includes
determining neighboring phase values from pixels that neighbor the at least one pixel,
determining whether the at least one pixel is valid,
determining a valid pixel from the pixels that neighbor the at least one pixel in response to determining that the at least one pixel is not valid,
determining an offset value from a neighboring phase value of the valid pixel,
shifting the phase value and the neighboring phase values by the offset value,
determining a weighted mean from the phase value that is shifted and the neighboring phase values that are shifted, and
generating a filtered phase value by shifting the weighted mean back by the offset value.

11. The method according to claim 8, wherein performing the phase filtering on the phase value further includes
determining neighboring phase values from pixels that neighbor the at least one pixel,
determining whether the at least one pixel is valid,
determining a offset value from the phase value in response to determining that the at least one pixel is valid,
shifting the phase value and the neighboring phase values by the offset value,
determining a weighted mean from the phase value that is shifted by the offset value and the neighboring phase values that are shifted by the offset value, and
generating a filtered phase value by shifting the weighted mean back by the offset value.

12. The method according to claim 8, wherein performing the phase filtering on the phase value further includes
determining horizontal and vertical components of the at least one pixel and pixels that neighbor the at least one pixel with respect to four quadrants,
calculating a weighted average of horizontal components of the at least one pixel and the pixels that neighbor the at least one pixel,
calculating a weighted average of vertical components of the at least one pixel and the pixels that neighbor the at least one pixel, and
calculating a weighted mean of circular angles based on the weighted average of the horizontal components and the weighted average of the vertical components,
wherein the weighted mean is a filtered phase value of the at least one pixel.

13. The method according to claim 8, wherein performing the phase filtering on the phase value further includes
determining horizontal and vertical components of the at least one pixel and pixels that neighbor the at least one pixel with respect to four quadrants,
responsive to determining that a majority of the horizontal and vertical components of the at least one pixel and pixels that neighbor the at least one pixel are in a first quadrant and a fourth quadrant of the four quadrants, shifting a phase value of the at least one pixel and neighboring phase values of the pixels that neighbor the at least one pixel by a 180 degrees, and
calculating a weighted average from the phase value that is shifted and the neighboring phase values that are shifted,
wherein the weighted average is a filtered phase value of the at least one pixel.

14. The method according to claim 8, wherein performing the phase filtering on the phase value further includes one of:
performing spatial phase filtering,
performing temporal phase filtering, or
performing a combination of spatial phase filtering and temporal phase filtering.

15. A non-transitory computer-readable medium comprising instructions that, when executed by an electronic processor, cause the electronic processor to perform a set of operations comprising:
determining a phase value from a depth signal that is generated by one pixel from an array of pixels; and
performing phase filtering on the phase value.

16. The non-transitory computer-readable medium according to claim 15, wherein performing the phase filtering on the phase value further includes
determining neighboring phase values from pixels that neighbor the at least one pixel,
determining an offset value from the phase value,
shifting the phase value and the neighboring phase values by the offset value that is determined,
determining a weighted mean from the phase value that is shifted and the neighboring phase values that are shifted, and
generating a filtered phase value by shifting the weighted mean back by the offset value.

17. The non-transitory computer-readable medium according to claim 15, wherein performing the phase filtering on the phase value further includes
determining neighboring phase values from pixels that neighbor the at least one pixel,
determining whether the at least one pixel is valid,
determining a valid pixel from the pixels that neighbor the at least one pixel in response to determining that the at least one pixel is not valid,
determining an offset value from a neighboring phase value of the valid pixel,
shifting the phase value and the neighboring phase values by the offset value,
determining a weighted mean from the phase value that is shifted and the neighboring phase values that are shifted, and
generating a filtered phase value by shifting the weighted mean back by the offset value.

18. The non-transitory computer-readable medium according to claim 15, wherein performing the phase filtering on the phase value further includes
determining neighboring phase values from pixels that neighbor the at least one pixel,
determining whether the at least one pixel is valid,
determining a offset value from the phase value in response to determining that the at least one pixel is valid,
shifting the phase value and the neighboring phase values by the offset value,
determining a weighted mean from the phase value that is shifted by the offset value and the neighboring phase values that are shifted by the offset value, and
generating a filtered phase value by shifting the weighted mean back by the offset value.

19. The non-transitory computer-readable medium according to claim 15, wherein performing the phase filtering on the phase value further includes
determining horizontal and vertical components of the at least one pixel and pixels that neighbor the at least one pixel with respect to four quadrants,
calculating a weighted average of horizontal components of the at least one pixel and the pixels that neighbor the at least one pixel,
calculating a weighted average of vertical components of the at least one pixel and the pixels that neighbor the at least one pixel, and
calculating a weighted mean of circular angles based on the weighted average of the horizontal components and the weighted average of the vertical components,
wherein the weighted mean is a filtered phase value of the at least one pixel.

20. The non-transitory computer-readable medium according to claim 15, wherein performing the phase filtering on the phase value further includes
determining horizontal and vertical components of the at least one pixel and pixels that neighbor the at least one pixel with respect to four quadrants,
responsive to determining that a majority of the horizontal and vertical components of the at least one pixel and pixels that neighbor the at least one pixel are in a first quadrant and a fourth quadrant of the four quadrants, shifting a phase value of the at least one pixel and neighboring phase values of the pixels that neighbor the at least one pixel by a 180 degrees, and
calculating a weighted average from the phase value that is shifted and the neighboring phase values that are shifted,
wherein the weighted average is a filtered phase value of the at least one pixel.
